(19) United States
(12) Patent Application Publication
(10) Pub. No.: US 2011/0111673 A1
(43) Pub. Date: May 12, 2011

(54) ANTISLIPPING TAPE AND TEXTILE PRODUCTS

(75) Inventor: Tsuyoshi Soeda, Osaka-shi (JP)

(73) Assignee: TEIJIN FIBERS LIMITED, Osaka-shi, Osaka (JP)

(21) Appl. No.: 13/003,274

(22) PCT Filed: Jun. 9, 2009
(86) PCT No.: PCT/JP2009/060520

§ 371 Date: Jan. 7, 2011

(30) Foreign Application Priority Data
Oct. 22, 2008 (JP) 2008-271875

(51) Int. Cl. C09J 7/04; A41D 1/06; A41D 1/14; A41B 11/00; A41B 9/04; A41C 3/00; A41C 1/00; A41D 13/00; A41B 9/00; A42B 1/00; A41D 19/00; A43B 17/00; B32B 5/02; B32B 5/00

(52) U.S. Cl. 450/1; 2/227; 2/211; 2/239; 2/406; 450/94; 2/69; 2/400; 2/171; 2/159; 442/189; 442/309; 442/184; 442/306; 428/220

(57) ABSTRACT

[Problem] There are provided an antislipping tape having an excellent antislipping effect, and comfortable to the skin, and textile products including the antislipping tape.

[Means for Resolution] Using a filament yarn A with a single filament diameter of 10 to 1000 nm, a cloth having a woven fabric structure or a knitted fabric structure is obtained. Using the cloth, an antislipping tape is obtained. Then, using the antislipping tape, textile products such as brassiere are obtained.

### TECHNICAL FIELD

The present invention relates to an antislipping tape capable of being attached to the inner sides of trousers, skirts, inner wear products, and the like, and having an excellent antislipping effect, and comfortable to the skin, and textile products.

### BACKGROUND ART

Conventionally, as the antislipping tapes, there are known those using elastic materials such as a polyurethane fiber and rubber, those obtained by processing a silicone resin into a tape, and the like (e.g., see Patent Document 1, and Patent Document 2).

However, with the antislipping tape using an elastic material such as a polyurethane fiber or rubber, a pressure is applied to the body during use thereof, which may cause an unwell feeling or poor blood circulation.

On the other hand, with the antislipping tape obtained by processing a silicone resin into a tape, the air permeability or the moisture permeability is inhibited by the tape. For this reason, there has been a problem that the antislipping effect of the tape is remarkably reduced by the moisture collected between the tape and the skin due to sweating or rain. Further, there has been another problem that a stuffy feeling is caused. Furthermore, the coated silicone resin may be in a convex form according to processing, so that there has been a still other problem that a concave-shaped line remains in the skin.
[Patent Document 1] Japanese Utility Model Registration No. 3079609
[Patent Document 2] JP-UM-B-61-18064

### DISCLOSURE OF THE INVENTION

### Problem that the Invention is to Solve

The present invention was completed in view of the foregoing background. It is an object thereof to provide an antislipping tape having an excellent antislipping effect, and comfortable to the skin, and textile products.

### Means for Solving the Problem

The present inventors conducted a close study in order to attain the foregoing problem. As a result, they found as follows: when an antislipping tape is formed using a fiber with a very small single filament diameter, it is possible to obtain an antislipping tape having a more excellent antislipping effect as compared with a conventional antislipping tape, and comfortable to the skin. A further continued close study has led to the completion of the present invention.

Thus, in accordance with the present invention, there is provided “an antislipping tape containing a cloth having a woven fabric structure or a knitted fabric structure, characterized in that the cloth comprises a filament yarn A with a single filament diameter of 10 to 1000 nm”.

In the cloth, it is preferable that the filament yarn A is exposed at the surface of the cloth. Further, it is preferable that the number of filaments of the filament yarn A is 500 or more. Still further, it is preferable that the filament yarn A is a yarn obtained by dissolving and removing a sea component of a sea-island type composite fiber including the sea component and an island component. Furthermore, it is preferable that the filament yarn A includes polyester.

It is preferable that the cloth contains therein a filament yarn B with a single filament diameter of more than 1000 nm as another fiber. Further, it is preferable that the number of filaments of the filament yarn B falls within the range of 1 to 500. Furthermore, it is also acceptable that the filament yarn B is an elastic yarn.

It is preferable that on the surface of the cloth, the frictional resistance value is 40 cN or more, provided that the frictional resistance value is a resistance value (cN) measured in the following manner. Namely, silicone rubber is put on a smooth stage under environment of a temperature of 20° C. and a humidity of 65% RH. Then, on the silicone rubber, there is placed a head with dimensions of a bottom of 5 cm×4 cm, a height of 3 cm, and a weight of 35 cN (36 gr), the head including a sample attached on the underside thereof. Then, the resistance value (cN) when the head has been pulled by means of a tensile tester at a rate of 100 mm/min is referred to as the frictional resistance value.

Whereas, it is preferable that the width of the antislipping tape falls within the range of 3 to 100 mm.

In accordance with the invention, there is provided a textile product which includes the antislipping tape, and is any selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

### Advantage of the Invention

In accordance with the present invention, it is possible to obtain an antislipping tape having an excellent antislipping effect, and comfortable to the skin, and textile products.

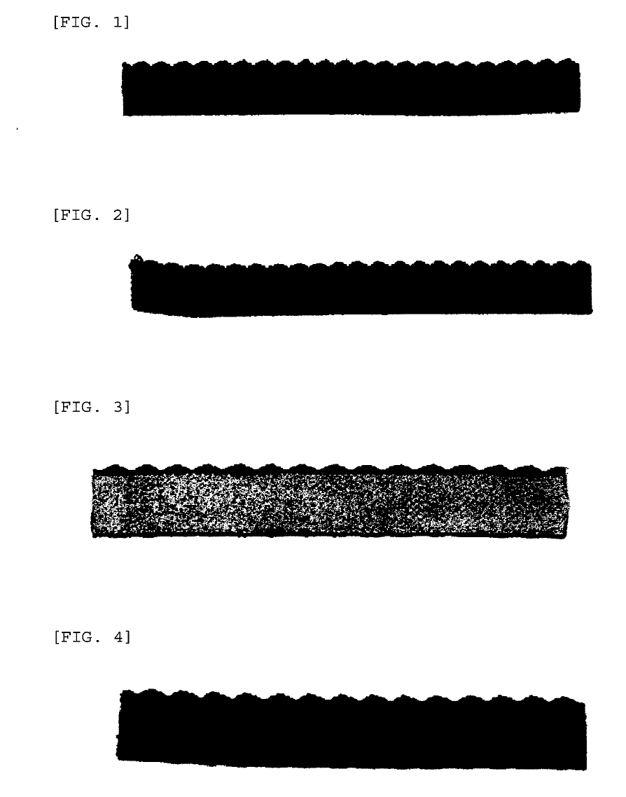

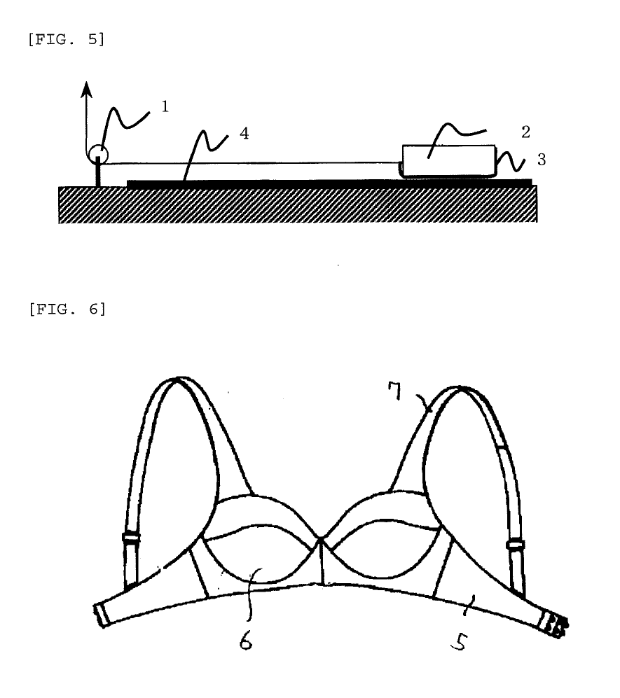

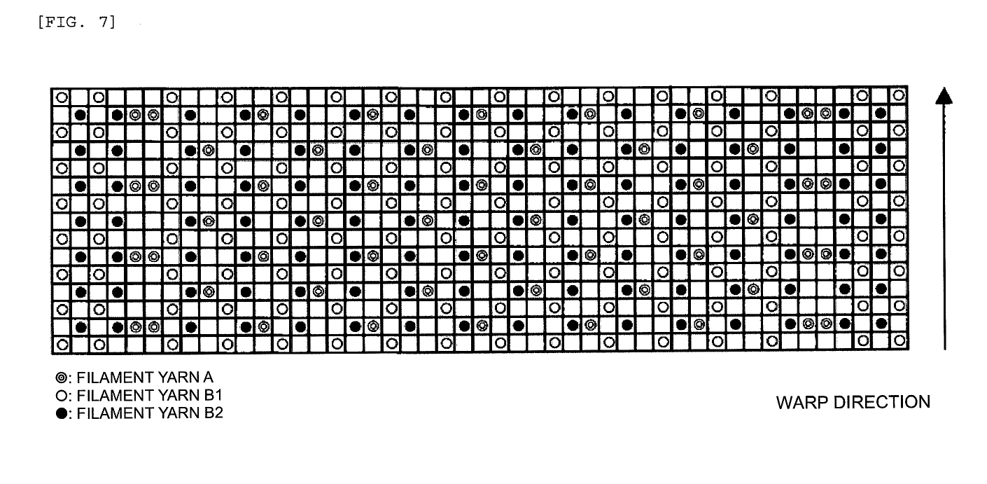

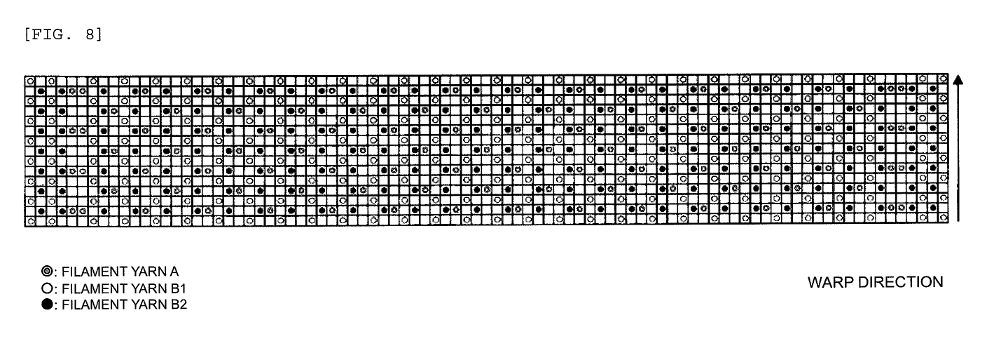

### BRIEF DESCRIPTION OF THE DRAWINGS

[FIG. 1] A photograph substituted for drawing of an antislipping tape (a strap for brassiere) obtained in Example 1;

[FIG. 2] A photograph substituted for drawing of an antislipping tape (a strap for brassiere) obtained in Comparative Example 1;

[FIG. 3] A photograph substituted for drawing of an antislipping tape (upper or under side tape for brassiere) obtained in Example 2;

[FIG. 4] A photograph substituted for drawing of an antislipping tape (upper or lower side tape for brassiere) obtained in Comparative Example 2;

[FIG. 5] A view schematically showing the measuring method of the frictional resistance value;

[FIG. 6] A view schematically showing the brassier;

[FIG. 7] A woven weave diagram used in Example 1; and

[FIG. 8] A woven weave diagram used in Example 2.

### REFERENCE NUMERALS AND SIGNS OF THE DRAWINGS

1: Pulley
2: Head
3: Sample
4: Silicone rubber
5: Wing part
6: Cup part
7: Shoulder strap (strap)

### BEST MODE FOR CARRYING OUT THE INVENTION

Below, embodiments of the present invention will be described in details.

An antislipping tape of the invention is an antislipping tape containing a cloth having a woven fabric structure or a knitted fabric structure, wherein the cloth contains therein a filament A with a single filament diameter of 10 to 1000 nm.

In the filament yarn A, it is essential that the single filament diameter (the diameter of the single filament) falls within the range of 10 to 1000 nm (preferably 250 to 800 nm, and in particular preferably 510 to 800 nm). Such a single filament diameter corresponds to 0.000001 to 0.01 dtex in terms of the single filament fineness. When the single filament diameter is smaller than 10 nm, the fiber strength is reduced, and hence such a case is practically undesirable. On the contrary, when the single filament diameter is larger than 1000 nm, a sufficient antislipping effect may not be obtained, which is undesirable. Herein, when the cross-sectional shape of the filament is a modified cross-section other than a round cross-section, the diameter of the circumcircle is assumed to be the single filament diameter. Incidentally, the single filament diameter can be measured by photographing the cross-section of the fiber by a transmission electron microscope.

In the filament yarn A, the number of filaments has no particular restriction. For obtaining an excellent antislipping effect, the number is preferably 500 or more (more preferably 2000 to 50000). Further, the total fineness of the filament yarn A (the product of the single filament fineness and the number of filaments) preferably falls within the range of 30 to 800 dtex.

The fiber form of the filament yarn A has no particular restriction, but is preferably a long filament (multifilament yarn). The cross-sectional shape of the single filament also has no particular restriction, and known cross-sectional shapes such as round, triangle, flat, and hollow shapes are acceptable. Further, general air processing or false twisting and crimping may have been performed thereon.

The type of the polymer forming the filament yarn A has no particular restriction. However, polyester type polymers or nylon type polymers are preferred. For example, there are preferably exemplified polyethylene terephthalate, polytrimethylene terephthalate, polybutylene terephthalate, polylactic acid, and a third component-copolymerized polyester. Such polyesters may be polyesters subjected to material recycling or chemical recycling. Further, they may also be polyesters obtained by using catalysts containing specific phosphorus compounds and titanium compounds as described in JP-A-2004-270097 and JP-A-2004-211268, polylactic acid, and stereocomplex polylactic acid. The polyester polymers may contain therein one or two or more of a micropore forming agent, a cationic dye mordant, a coloring inhibitor, a thermal stabilizer, a fluorescent brightening agent, a matting agent, a coloring agent, a moisture absorbent, and inorganic fine particles.

The cloth contained in the antislipping tape of the invention may include only the filament yarn A. However, when the cloth includes the filament yarn A and a filament B with a single filament diameter of more than 1000 nm as another fiber, the shape retentivity of the antislipping tape is preferably improved.

Herein, the filament yarn B preferably has a single filament diameter of more than 1000 nm (preferably 2 to 33 μm). Incidentally, 33 μm is about 10 dtex in terms of the fineness. When the single filament diameter of the filament yarn B is 1000 nm (1 μm) or less, the shape retentivity of the tape may be damaged. Herein, when the cross-sectional shape of the single filament is a modified cross-section other than a round cross-section, the diameter of the circumcircle is assumed to be the single filament diameter. Incidentally, the single filament diameter can be measured by photographing the cross-section of the fiber by a transmission electron microscope as with the foregoing.

In the filament yarn B, the number of filaments has no particular restriction, but preferably falls within the range of 1 to 300. Further, the fiber form of such a filament yarn B has no particular restriction, and a spun yarn is also acceptable. Particularly, a long filament (multifilament yarn), a polyurethane fiber, or the like, or both are preferably used. The cross-sectional shape of the filament also has no particular restriction, and known cross-sectional shapes such as round, triangle, flat, and hollow shapes are acceptable. Further, general air processing or false twisting and crimping may have been performed thereon. Further, the filament yarn B may come in one kind, or a plurality of kinds such as a filament yarn B1, a filament yarn B2, a filament yarn B3, and the like.

The type of the polymer forming the filament yarn B has no particular restriction. Especially, there are preferably exemplified polyethylene terephthalate, polytrimethylene terephthalate, polybutylene terephthalate, polylactic acid, stereocomplex polylactic acid, a third component-copolymerized polyester, polyether ester, urethane, and the like. Such polyesters may be polyesters subjected to material recycling or chemical recycling. Further, they may also be polyesters obtained by using catalysts containing specific phosphorus compounds and titanium compounds as described in JP-A-2004-270097 and JP-A-2004-211268, polylactic acid, and stereocomplex polylactic acid. Out of these, when the antislipping effect is more improved, an elastic resin such as polyether ester or polyurethane is preferred. The polymer forming the filament yarn B may contain therein one or two or more of a micropore forming agent, a cationic dye mordant, a coloring inhibitor, a thermal stabilizer, a fluorescent brightening agent, a matting agent, a coloring agent, a moisture absorbent, and inorganic fine particles.

Incidentally, the filament yarn B may be a composite yarn. For example, preferred are a composite yarn obtained by air-mixing an elastomer fiber yarn including a polyurethane fiber, a polyether ester type fiber, or the like, and a polyester type fiber yarn by an interlace air nozzle or the like, a composite yarn obtained by covering the periphery of the elastomer fiber yarn with a polyester type yarn, a composite yarn using a spun yarn, and the like.

In the cloth contained in the antislipping tape of the invention, it is preferable that the filament A is exposed at either one surface of the front and back. For example, use in such a manner that the filament A is in contact with the skin improves the friction with the skin, resulting in an excellent antislipping effect. Herein, the fabric surface is photographed at a magnification of 50 times by means of an electron microscope. In the photograph, the area AA occupied by the filament yarn A and the area BA occupied by the filament yarn B are measured. The value of the area ratio (%) of the filament yarn A (=AA/(AA+BA)×100) is preferably 30% or more (preferably 100%). Particularly, it is preferable that only the filament yarn A is exposed at either one surface of the front and back of the cloth. When the antislipping tape is used in such a manner that the surface at which only the filament yarn A is exposed is used on the skin side, the friction with the skin is improved, resulting in an excellent antislipping effect.

The antislipping tape of the invention can be manufactured by, for example, the following manufacturing method. First, a sea-island type composite fiber (fiber for filament yarn A) formed of a sea component, and an island component with a diameter of 10 to 1000 nm is prepared. As such a sea-island type composite fiber, the sea-island type composite fiber multifilament (number of islands 100 to 1500) disclosed in JP-A-2007-2364 is preferably used.

Namely, as the sea component polymer, an alkaline aqueous solution-easily soluble polymer is used. As such an alkaline aqueous solution-easily soluble polymer, preferred are polylactic acid, ultrahigh molecular weight polyalkylene oxide condensation type polymers, polyethylene glycol type compound copolymerized polyester, copolymerized polyesters of a polyethylene glycol type compound and 5-sodium sulfonate isophthalate. Out of these, preferred is polyethylene terephthalate type copolymerized polyester with an intrinsic viscosity of 0.4 to 0.6 resulting from copolymerization of 6 to 12 mol % 5-sodium sulfoisophthalic acid and 3 to 10 wt % polyethylene glycol with a molecular weight of 4000 to 12000.

On the other hand, as the island component polymers, preferred are polyesters such as fiber-formable polyethylene terephthalate, polytrimethylene terephthalate, polybutylene terephthalate, polylactic acid, and a third component-copolymerized polyester. The polymer may contain therein, if required, within such a range as not to impair the object of the invention, one or two or more of a micropore forming agent, a cationic dye mordant, a coloring inhibitor, a thermal stabilizer, a fluorescent brightening agent, a matting agent, a coloring agent, a moisture absorbent, and inorganic fine particles.

For the sea-island type composite fiber including the sea component polymer and the island component polymer, it is preferable that the melt viscosity of the sea component during melt spinning is larger than the melt viscosity of the island component polymer. Whereas, the diameter of the island component is required to be within the range of 10 to 1000 nm. In that case, when the shape of the island component is not a perfect circle, the diameter of the circumcircle is determined. In the sea-island type composite fiber, the sea-island composite weight ratio (sea:island) is preferably within the range of 40:60 to 5:95, and in particular preferably within the range of 30:70 to 10:90.

Such a sea-island type composite fiber can be manufactured with, for example, the following method with ease. Namely, the sea component polymer and the island component polymer are used to be melt spun. As the spinnerets for use in melt spinning, there can be used given ones such as the one having a hollow pin group and a micropore group for forming the island component. The discharged sea-island type composite fiber is solidified by cooling air, and is melt spun at preferably 400 to 6000 m/min, followed by winding. The resulting undrawn yarn is preferably formed into a composite fiber having desirable strength/elasticity/thermal shrinking characteristics through an additional drawing step. Alternatively, the following process is also acceptable: the discharged sea-island type composite fiber is taken up with a roller at a constant rate without being once wound, and subsequently is subjected to a drawing step, followed by winding.

In thus obtained sea-island type composite fiber (multifilament), preferably, as the single filament fineness, the number of filaments, and the total fineness, the single filament fineness is 0.5 to 10.0 dtex, the number of filaments is 5 to 75, and the total fineness is 30 to 170 dtex, respectively. Whereas, the boiling water shrinkage of such a sea-island type composite fiber preferably falls within the range of 5 to 30%.

On the other hand, if required, a filament yarn B with a single filament diameter of larger than 1000 nm is prepared. The single filament fineness of such a filament yarn B is preferably 0.1 dtex or more (preferably 0.1 to 50 dtex). Further, in such a filament yarn B, as the number of filaments, and the total fineness, preferably, the number of filaments is 1 to 300 and the total fineness is 10 to 800 dtex, respectively.

The filament yarn B is preferably high shrinkage polyester with a boiling water shrinkage of 10% or more (more preferably 20 to 40%), or an elastic yarn (a polyurethane elastic yarn or a polyether ester elastic yarn). Incidentally, in order to obtain a high boiling water shrinkage as described above, it is desirable that spinning and drawing are performed using a copolymerized polyester with an ordinary method. In that case, preferably, as the copolymerized polyester, the main constituent monomers of the copolymerized polyester are terephthalic acid and ethylene glycol, and the third component to be copolymerized with the main constituent monomers is any selected from the group consisting of isophthalic acid, naphthalene dicarboxylic acid, adipic acid, sebacic acid, diethylene glycol, polyethylene glycol, bisphenol A, and bisphenol sulfone. Particularly, the copolymerized polyester is preferably a copolymerized polyester in which the acid components include terephthalic acid and isophthalic acid with a mole ratio (terephthalic acid/isophthalic acid) of 90/5 to 85/15, and the glycol component includes ethylene glycol. Use of such a copolymerized polyester provides high boiling water shrinkage.

Then, using the sea-island type composite fiber, and if required, the filament yarn B, a cloth is woven or knitted with an ordinary method. In such a cloth, it is preferable that the sea-island type composite fiber is exposed at either one surface of the front or back of the cloth.

In that case, the sea-island type composite fiber and the filament yarn B may be contained as the combined filament yarn in the cloth. However, it is preferable that the filament yarn A and the filament B are interknitted or interwoven, thereby to weave or knit a cloth (knitted fabric or woven fabric). As the weaving or knitting machine to be used, preferred is a known weaving machine for ribbons (e.g., needle weaving machine, manufactured by Jacob Muller Co., (Germany), or NJK machine manufactured by TOMINAGA MACHINE MANUFACTURING Co., Ltd).

When not only the sea-island type composite fiber but also the filament yarn B are used, the total fineness ratio of the sea-island type composite fiber and the filament yarn B preferably falls within the range of 90:10 to 20:80.

Herein, the construction of the cloth has no particular restriction. For example, as the weft knit constructions, mention may be made of plain stitch, rib stitch, interlock stitch, purl stitch, tuck stitch, float stitch, half cardigan stitch, lace stitch, and plated stitch. As the warp knit constructions, mention may be made of single denbigh stitch, single atlas stitch, double cord stitch, half stitch, half base stitch, satin stitch, half tricot stitch, fleecy stitch, jacquard stitch, and the like. As the woven fabric structures, mention may be made of three foundation weaves such as plain weave, twill weave, and sateen weave, derivative weave, partial backed weaves such as warp backed weave and weft backed weave, warp velvet, and the like. It is naturally understood that these are non-limiting. Also for the number of layers, a monolayer is acceptable, or a multilayer of two layers or more is also acceptable.

Then, the cloth is subjected to an alkaline aqueous solution treatment, so that the sea component of the sea-island type composite fiber is dissolved in an alkaline aqueous solution and removed. Then, the sea-island type composite fiber is formed into a filament yarn A with a single filament diameter of 10 to 1000 nm. As a result, a cloth containing the a filament yarn A with a single filament diameter of 10 to 1000 nm is obtained.

In that step, as the conditions for the alkaline aqueous solution treatment, it is essential only that the treatment is performed using an NaOH aqueous solution with a concentration of 3 to 4% at a temperature of 55 to 65° C.

Further, in the pre-step and/or the post-step of the dissolution and removal treatment step with the alkaline aqueous solution, the fabric may be subjected to dyeing and finishing. Calendering (heating and pressurizing processing) and embossing may be performed. Further, ordinary-method raising, and water-repellent finish, and further, various processings of imparting functions of ultraviolet shielding or antistatic agent, antimicrobial agent, deodorant, insect repellent, light storage agent, retro-reflecting agent, minus ion generator, and the like may be applied.

The antislipping tape of the invention may include only the cloth, but may include the cloth and another cloth. For example, a multilayer structure may be adopted by disposing the cloth on the skin side, and, on the other hand, for example, disposing a general polyester woven or knitted fabric on the outside air side.

In the thus obtained antislipping tape, the width thereof preferably falls within the range of 3 to 100 mm (more preferably 5 to 50 mm).

The antislipping tape of the invention includes a cloth containing a filament yarn A with a single filament diameter of 10 to 1000 nm, and hence has an excellent antislipping effect and is comfortable to the skin.

The reason why the excellent antislipping effect can be obtained in antislipping tape of the invention has not yet been clarified. However, this is presumed to be due to the following fact: the cloth surface becomes flat, so that the contact area with an object (e.g., skin) increases; or the filament yarn A is caught in the asperities of the object (e.g., skin).

Whereas, in antislipping tape of the invention, the frictional resistance value is preferably 40 cN or more (preferably 40 to 50 cN) in a dry state (under environment of a temperature of 20° C. and a humidity of 65% RH). Whereas, in a wet state, the value is preferably 45 cN or more (preferably 45 to 100 cN). However, the frictional resistance value is the resistance value (cN) measured in the following manner. Namely, as schematically shown in FIG. 5, silicone rubber is put on a smooth stage. Then, on the silicone rubber, there is placed a head with dimensions of a bottom of 5 cm×4 cm, a height of 3 cm, and a weight of 36 gr (35 cN), the head including a sample attached on the underside thereof. Then, the resistance value (cN) when the head has been pulled by means of a tensile tester at a rate of 100 mm/min is referred to as the frictional resistance value. Further, the wet state includes two levels of the state of the sample added with 0.1 cc of water, and the state of the sample after 30 seconds from pulling up from the state in which the sample was fully immersed in water to sufficiently contain water.

Whereas, when the antislipping tape of the invention contains a filament yarn B with a single filament diameter of larger than 1000 nm, the shape retentivity of the tape is improved.

The textile products of the invention are any textile products which include the antislipping tape, and are selected from the group consisting of trousers, skirts, socks, stockings, brassieres, short panties, lingerie, girdles, men's pants, women's pants, sport undershirts, sport underpants, jersey, and hats, and gloves. Use of the antislipping tape in such a textile product so that the surface at which the filament A is exposed is in contact with the skin provides an excellent antislipping effect. Further, the product is also excellent in water absorption, and is also comfortable to the skin.

### EXAMPLES

Then, Examples and Comparative Examples of the invention will be described in details. However, the invention is not limited thereby. Incidentally, respective measurement items in Examples were measured in the following manner.

### <Melt Viscosity>

A polymer after a drying treatment is set in an orifice set at the ruder melting temperature for spinning, and is molten and held for 5 minutes, and then, is extruded under loads at several levels. The shear rate and the melt viscosity at that step are plotted. The plots are gently connected to form a shear rate—melt viscosity curve. Then, the melt viscosity at a shear rate of 1000 sec⁻¹ is observed.

### <Dissolution Rate>

A yarn is wound at a spinning rate of 1000 to 2000 m/min through respective 0.3-dia-0.6 L×24 H spinnerets of the sea/island components, and further is drawn so that the residual elasticity falls within the range of 30 to 60%, thereby to manufacture a multifilament of 84 dtex/24 fil. At a temperature at which this is tried to be dissolved in respective solvents, and at a bath ratio of 100, the reduction rate was calculated from the dissolution time and the dissolution amount.

### <Single Filament Diameter>

The cloth was photographed by an electron microscope, and then, the single filament diameters of samples, the number n of which is 5, were measured, and the mean value thereof was determined.

### <Area Ratio of Filament Yarn a Exposed at the Surface of Cloth>

The cloth surface was photographed at a magnification of 50 times by means of an electron microscope. In the photograph, the area AA occupied by the filament yarn A and the area BA occupied by the filament yarn B were measured, and the area ratio (%) of the filament yarn A was calculated.

Area ratio of filament yarn A (%)=AA/(AA+BA)×100

### <Frictional Resistance Value>

As the substitute characteristic of the frictional force, the frictional resistance value (cN) was measured in the following manner. Namely, under environment of a temperature of 20° C. and a humidity of 65% RH, as schematically shown in FIG. 5, silicone rubber was put on a smooth stage. Then, on the silicone rubber, there was placed a head with dimensions of a bottom of 5 cm×4 cm, a height of 3 cm, and a weight of 36 gr (35 cN), the head including a sample attached on the underside thereof. Then, the resistance value (cN) when the head had been pulled by means of a tensile tester at a rate of 100 mm/min was measured. Further, the wet state includes two levels of the state of the sample added with 0.1 cc of water, and the state of the sample after 30 seconds from pulling up from the state in which the sample was fully immersed in water to sufficiently contain water.

### <Antislipping Property>

For straps for brassieres obtained in Example 1, upper and lower side tapes for brassieres obtained in Example 2, straps for brassieres obtained in Comparative Example 1, and upper and lower side tapes for brassieres obtained in Comparative Example 2, ten testers performed a wear test for one month. At that step, in the movement in daily life, for the straps, whether they slip off the shoulders or not, and for the upper and lower side tapes, the feeling of slipping between the contact part and the skin were rated on the following scale of three grades (grade 3: hardly slip even by any movement; grade 2: may slip by a large movement; and grade 1: may slip by a simple movement).

### <Hand Test>

A hand test was performed simultaneously with the antislipping property test with the skin, and the texture was rated on the following scale of 3 grades. Grade 3: comfortable to the skin and causing no uncomfortable feeling; grade 2: slightly causing uncomfortable feeling; and grade 1: remarkably causing uncomfortable feeling.

### Example 1

Using polyethylene terephthalate (with a melt viscosity at 280° C. of 1200 poise, and a matting agent content: 0 wt %) as the island component, and polyethylene terephthalate (with a melt viscosity at 280° C. of 1750 poise) obtained by copolymerizing 6 mol % 5-sodium sulfoisophthalic acid and 6 wt % polyethylene glycol with a number-average molecular weight of 4000 as a sea component (dissolution rate ratio (sea/island)=230), a sea-island type composite undrawn fiber with sea:island=30:70, and the number of islands=836 was melt spun at a spinning temperature of 280° C. and at a spinning rate of 1500 m/min, and was wound once.

The resulting undrawn yarn was roller drawn at a drawing temperature of 80° C., and at a draw ratio of 2.5 times, and then, was heat set at 150° C., and was wound. The resulting sea-island type composite fiber (drawn yarn for the filament yarn A) had 56 dtex/10 fil. The fiber cross-section was observed by a transmission electron microscope TEM. As a result, the shape of the island was a round shape, and the diameter of the island was 710 nm.

On the other hand, as the filament yarn B1, there was prepared a stretchable composite yarn obtained by covering a commercially available polyurethane elastic yarn (fineness 470 dtex/1 fil, manufactured by Asahi Kasei Corporation Ltd.,) with a commercially available polyester false twisted and crimped textured yarn of 167 dtex/72 fil. Further, as the filament yarn B2, a commercially available polyester false twisted and crimped textured yarn of 167 dtex/48 fil was prepared. Furthermore, as the filament yarn B3, a commercially available non-crimped polyester drawn yarn of 110 dtex/48 fil was prepared.

Then, using a weaving machine for ribbons (needle weaving machine, manufactured by Jacob Muller Co.), yarns were combined so that the back side of the fabric (tape) exerts an antislipping effect with the skin. Namely, as the warps, there were used 15 yarns of the sea-island type composite fiber composite yarn (for the back side) of 224 dtex/40 fil obtained by uniting four yarns of the sea-island type composite fiber of 56 dtex/10 fil, 16 yarns of the filament yarn B1 (for intermediate weave), and 16 yarns of the filament yarn B2 (for the front side), respectively. On the other hand, for the weft, the filament yarn B3 was used. Then, a 10-mm wide woven fabric having elasticity in a reversible structure was obtained. At that step, the woven weave diagram shown in FIG. 7 was used. Herein, the filament yarn B3 is a weft, the woven weave diagram shows the arrangement of respective yarns as seen from the surface, and hence the blank portion of the diagram is the filament yarn B3.

Then, in order to remove the sea component of the sea-island type composite fiber, the cloth was subjected to 30% alkali peeling in a 3.5% NaOH aqueous solution at 70° C. Thereafter, high-pressure dyeing at 130° C. and for 30 minutes was performed. Then, as the final setting, 170° C. dry heat setting was performed, resulting in a cloth (antislipping tape) containing the filament yarn A.

In the resulting cloth, the filament diameter of the single filament yarn A (39 dtex/8360 fil) was 710 nm. Whereas, in the filament yarn B1, the single filament diameter of the polyurethane fiber was 160 μm, and the single filament diameter of 167 dtex/72 fil used for covering was 16 μm. Further, the single filament diameter of the filament yarn B2 was 19 μm. Still further, the single filament diameter of the filament yarn B3 was 16 μm. Whereas, on the back side surface (skin side) of the cloth, 90% or more of the filament yarn A was exposed. As shown in Table 1, the frictional resistance value of the back side surface of the cloth was 1.5 times or more that of the cloth obtained in Comparative Example 1 either in a dray state or in a wet state.

A wear test was performed using the cloth for a strap for brassiere (shoulder strap) as an antislipping tape in place of a commercially available strap for brassiere. As a result, as shown in Table 2, the tape was superior in antislipping property with the skin to Comparative Example 1. Incidentally, the tape was attached by sewing so that the tape back side (on which 90% or more of the filament yarn A was exposed) was situated on the skin side.

### Comparative Example 1

In Example 1, in place of the sea-island type composite fiber, a common polyethylene terephthalate multifilament drawn yarn (total fineness 168 dtex/48 fil, manufactured by TEIJIN FIBERS LIMITED) was used. Further, alkali peeling was not performed. Except for this, a tape was obtained in the same manner as in Example 1. In the resulting tape, the single filament diameter of the polyethylene terephthalate multifilament drawn yarn was 19 μm.

TABLE 1

| | Surface frictional resistance (cN) | | |
|---|---|---|---|
| | | Wet state | |
| | Dry state | 0.1 cc dropwise addition | Saturation |
| Example 1 | 50.7 | 52.8 | 62.8 |
| Comparative | 28.2 | 34.3 | 30.0 |
| Example 1 | | | |

TABLE 2

| | Evaluation items | | | | | |
|---|---|---|---|---|---|---|
| | Antislipping property | | | | | |
| | with the skin | | | Texture | | |
| | Grade 3 | Grade 2 | Grade 1 | Grade 3 | Grade 2 | Grade 1 |
| Example 1 | 8 | 2 | 0 | 9 | 0 | 1 |
| Comparative | 0 | 0 | 10 | 0 | 10 | 0 |
| Example 1 | | | | | | |

### Example 2

Using polyethylene terephthalate (with a melt viscosity at 280° C. of 1200 poise, and a matting agent content: 0 wt %) as the island component, and polyethylene terephthalate (with a melt viscosity at 280° C. of 1750 poise) obtained by copolymerizing 6 mol % 5-sodium sulfoisophthalic acid and 6 wt % polyethylene glycol with a number-average molecular weight of 4000 as a sea component (dissolution rate ratio (sea/island)=230), a sea-island type composite undrawn fiber with sea:island=30:70, and the number of islands=836 was melt-spun at a spinning temperature of 280° C. and at a spinning rate of 1500 m/min, and was wound once.

The resulting undrawn yarn was roller drawn at a drawing temperature of 80° C., and at a draw ratio of 2.5 times, and then, was heat set at 150° C., and was wound. The resulting sea-island type composite fiber (drawn yarn for polyester filament yarn A) had 56 dtex/10 fil. The fiber cross-section was observed by a transmission electron microscope TEM. As a result, the shape of the island was a round shape, and the diameter of the island was 710 nm.

On the other hand, as the filament yarn B1, there was prepared a stretchable textured yarn obtained by covering a commercially available polyurethane elastic yarn (fineness 470 dtex/1 fil, manufactured by Asahi Kasei Corporation Ltd.,) with a commercially available polyester false twisted and crimped textured yarn of 167 dtex/72 fil. Further, as the filament yarn B2, a commercially available polyester false twisted and crimped textured yarn of 167 dtex/48 fil was prepared. Furthermore, as the filament yarn B3, a commercially available non-crimped polyester drawn yarn of 110 dtex/48 fil was prepared.

Then, using a weaving machine for ribbons (single needle ribbon weaving machine, manufactured by Jacob Muller Co.), yarns were combined so that the back side of the cloth (antislipping tape) exerts an antislipping effect with the skin. Namely, as the warps, there were used 30 yarns of the sea-island type composite fiber composite yarn (for the back side) of 224 dtex/40 fil obtained by uniting four yarns of the sea-island type composite fiber of 56 T 10 fil, and, 30 yarns of the filament yarn B1 (for intermediate weave), and for the front side of the tape, 30 yarns of the filament yarn B2 (for the front side), respectively. On the other hand, for the weft, the filament yarn B3 was used. Then, a 14-mm wide tape having elasticity in a reversible structure was obtained. At that step, the woven weave diagram shown in FIG. 8 was used. Herein, the filament yarn B3 is a weft, the woven weave diagram shows the arrangement of respective yarns as seen from the surface, and hence the blank portion of the diagram is the filament yarn B3.

Then, in order to remove the sea component of the sea-island type composite fiber, the tape was subjected to 30% alkali peeling in a 3.5% NaOH aqueous solution at 70° C. Thereafter, high-pressure dyeing at 130° C. and for 30 minutes was performed, and as the final setting, 170° C. dry heat setting was performed, resulting in a cloth containing the filament yarn A.

In the resulting cloth, the filament diameter of the single filament yarn A (39 dtex/8360 fil) was 710 nm. Whereas, in the filament yarn B1, the single filament diameter of the polyurethane fiber was 220 μm, and the single filament diameter of 167 dtex/72 fil used for covering was 16 μm. Further, the single filament diameter of the filament yarn B2 was 19 μm. Still further, the single filament diameter of the filament yarn B3 was 16 μm. Whereas, on the back side surface of the cloth (antislipping tape), 90% or more of the polyester filament yarn A was exposed. The frictional resistance value of the back side (skin side) surface of the cloth was 1.5 times or more that of the cloth obtained in Comparative Example 2 either in a dry state or in a wet state. A wear test was performed using the cloth as an antislipping tape in place of a commercially available upper or lower side tape for brassiere (tapes attached to the upper side and the lower side of the skin side surface of the cup part). As a result, as shown in Table 4, the tape was superior in antislipping property with the skin to Comparative Example 2. Incidentally, the antislipping tape was attached by sewing so that the tape back side was on the skin side.

### Comparative Example 2

In Example 2, in place of the sea-island type composite fiber, a common polyethylene terephthalate multifilament drawn yarn (total fineness 168 dtex/48 fil, manufactured by TEIJIN FIBERS LIMITED) was used. Further, alkali peeling was not performed. Except for this, a tape was obtained in the same manner as in Example 2. In the resulting tape, the single filament diameter of the polyethylene terephthalate multifilament drawn yarn was 19 μm.

TABLE 3

| | Surface frictional resistance (cN) | | |
|---|---|---|---|
| | | Wet state | |
| | Dry state | 0.1 cc dropwise addition | Saturation |
| Example 2 | 60.2 | 66.9 | 77.2 |
| Comparative | 29.5 | 35.0 | 30.2 |
| Example 2 | | | |

TABLE 4

| | Evaluation items | | | | | |
|---|---|---|---|---|---|---|
| | Antislipping property | | | | | |
| | with the skin | | | Texture | | |
| | Grade 3 | Grade 2 | Grade 1 | Grade 3 | Grade 2 | Grade 1 |
| Example 2 | 9 | 1 | 0 | 2 | 7 | 1 |
| Comparative | 2 | 8 | 0 | 0 | 10 | 0 |
| Example 2 | | | | | | |

### INDUSTRIAL APPLICABILITY

According to the present invention, there are provided an antislipping tape having an excellent antislipping effect, and comfortable to the skin, and textile products including the antislipping tape, the industrial values of which are very large.

1. An antislipping tape containing a cloth having a woven fabric structure or a knitted fabric structure, characterized in that the cloth comprises a filament yarn A with a single filament diameter of 10 to 1000 nm.

2. The antislipping tape according to claim 1, wherein in the cloth, the filament yarn A is exposed at the surface of the cloth.

3. The antislipping tape according to claim 1, wherein the number of filaments of the filament yarn A is 500 or more.

4. The antislipping tape according to claim 1, wherein the filament yarn A is a yarn obtained by dissolving and removing a sea component of a sea-island type composite fiber comprising the sea component and an island component.

5. The antislipping tape according to claim 1, wherein the filament yarn A comprises polyester.

6. The antislipping tape according to claim 1, wherein the cloth contains therein a filament yarn B with a single filament diameter of more than 1000 nm as another fiber.

7. The antislipping tape according to claim 6, wherein the number of filaments of the filament yarn B ranges from 1 to 500.

8. The antislipping tape according to claim 6, wherein the filament yarn B is an elastic yarn.

9. The antislipping tape according to claim 1, wherein on the surface of the cloth, the frictional resistance value is 40 cN or more,
provided that the frictional resistance value is a resistance value (cN) measured in the following manner: namely, silicone rubber is put on a smooth stage under environment of a temperature of 20° C. and a humidity of 65% RH; then, on the silicone rubber, there is placed a head with dimensions of a bottom of 5 cm×4 cm, a height of 3 cm, and a weight of 35 cN (36 gr), the head including a sample attached on the underside thereof; then, the resistance value (cN) when the head has been pulled by means of a tensile tester at a rate of 100 mm/min is referred to as the frictional resistance value.

10. The antislipping tape according to claim 1, wherein the width of the antislipping tape ranges from 3 to 100 mm.

11. Any textile product comprising the antislipping tape according to claim 1, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

12. Any textile product comprising the antislipping tape according to claim 2, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

13. Any textile product comprising the antislipping tape according to claim 3, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

14. Any textile product comprising the antislipping tape according to claim 4, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

15. Any textile product comprising the antislipping tape according to claim 5, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

16. Any textile product comprising the antislipping tape according to claim 6, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

17. Any textile product comprising the antislipping tape according to claim 7, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

18. Any textile product comprising the antislipping tape according to claim 8, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

19. Any textile product comprising the antislipping tape according to claim 9, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.

20. Any textile product comprising the antislipping tape according to claim 10, selected from the group consisting of trousers, skirts, socks, stockings, brassieres, short panties, lingerie, girdles, men's pants, women's pants, sport undershirts, sport underpants, jersey, hats, gloves, underwear, sporting goods, and sporting materials.
